(19) United States
(12) Patent Application Publication
(10) Pub. No.: US 2008/0169442 A1
(43) Pub. Date: Jul. 17, 2008

(54) Plug Valve

(75) Inventor: Grant A. Colton, Butler, PA (US)

Correspondence Address: THE WEBB LAW FIRM, P.C., 700 KOPPERS BUILDING, 436 SEVENTH AVENUE, PITTSBURGH, PA, 15219, US

(73) Assignee: GA INDUSTRIES INC., Cranberry Township, PA (US)

(21) Appl. No.: 12/013,032

(22) Filed: Jan. 11, 2008

Related U.S. Application Data
(60) Provisional application No. 60/880,591, filed on Jan. 16, 2007.

(51) Int. Cl. F16K 5/04

(52) U.S. Cl. 251/309

(57) ABSTRACT

A plug valve includes a valve body, an actuator, and an adapter. The valve body has an actuator end, a valve body end, and a stem chamber extending through said adapter. The valve body end of the adapter provides a valve body cover that can be attached to the valve body. The actuator end of the adapter is attached to the actuator by a threaded member extending through a set of holes of the adapter and the actuator. The adapter can have a bleedway in communication with the stem chamber for showing leakage. The holes of the adapter can be conforming to ISO standards for actuators.

### CROSS REFERENCE TO RELATED APPLICATIONS

This application is based on U.S. Provisional Patent Application No. 60/880,591, filed Jan. 16, 2007, on which priority of this patent application is based and which is hereby incorporated by reference in its entirety.

### BACKGROUND OF THE INVENTION

### Field of the Invention

The valve body of the present invention represents an improvement over the valve bodies of the prior art. Currently, valve bodies have non-standard interfaces for the installation of actuators. Since valves have to meet an infinite range of purposes and environmental conditions, this has led to an equally large number of valve actuators. The correct attachment of these actuators is essential for the efficient functioning of the valve assembly and its protection against damage in the field.

Valve assemblies can be expensive, especially large plug valves used in water treatment plants. They are invariably installed in large control schemes where reliability and accuracy is keynote and the cost of a breakdown is high.

Using standard interfaces leads to lower installation costs, reduces piping and possible site damage, easier and quicker maintenance and component replacement. Retrofitting to meet change of circumstances is promoted as the user is not “locked in” to a particular supplier. Users of valve bodies with standard interfaces will reduce costs and improve efficiencies from the introduction of standard interfaces between actuators and valves.

Conventionally, a plug valve includes a main valve body and a plug. The valve body is provided with a first inlet passage and a second outlet passage having their axes coincident with each other, and includes a columnar opening disposed between the first inlet passage and the second outlet passage. The plug valve is rotatably attached to the opening.

The plug valve has a through-hole penetrating therethrough in a direction substantially coincident with the axial direction of the first and second passages. Accordingly, the plug is constructed such that the liquid flows from the first passage through the through-hole to the second passage.

The plug is rotatable from a communication position at which the through-hole provided in the opening of the plug communicates with the first inlet passage and the second outlet passage, to an interruption position at which the liquid is prevented from flowing from the first passage to the second passage. Typically, an actuator is connected to the main valve body.

Traditionally, there were two methods of attaching an actuator to a plug valve. In one method, there is a mounting adaptor which is between the actuator and the valve cover. In another method, there is no adaptor and the actuator is attached directly to the valve cover. In the former, extra expense and inefficiencies are introduced into the arrangement. In the latter, it was necessary to remove the actuator cover in order to remove the bolts that secured the actuator to the valve cover. Since only one arrangement of attachment holes is made in the valve body corresponding to one actuator, the arrangements in the prior art have been proprietary arrangements, requiring the use of additional components to accommodate for differences between the valve body attachment holes and the actuator holes.

### SUMMARY OF THE INVENTION

A plug valve includes a valve body, an actuator and an adapter. The valve body includes a first end defining a set of holes and a first port and a second port. The actuator includes a portion defining a set of holes. The adapter includes an actuator end, a valve body end and a stem chamber extending through the adapter. The valve body end can be attached to the first end of the valve body by a member extending through a set of holes defined on a portion of the valve body end corresponding to a set of holes of the valve body. The actuator end of the adapter can be attached to the actuator by a member extending through a set of holes of a portion of the actuator end of the adapter into the corresponding receiving set of holes in the actuator. The adapter can provide a valve stem rotatably positioned in the said stem chamber having a valve end for attaching a valve member and having a communication hole for communicating with the first port and the second port.

The set of holes of the adapter can be spaced radially on the portion of the actuator end of the adapter conforming to a standard protocol. The standard protocol can be the ISO standard spacing protocol for valve actuators. The adapter can include additional holes for attaching actuators, wherein different spacing of the additional holes can conform to ISO standard spacing protocol. The portion of the actuator end of the adapter containing the set of holes can be a flange. The valve end can be a plug. The portion of said valve body end of the adapter containing the set of holes can be a flange. The valve body end of the adapter can define a valve body cover. The adapter can further include a bleedway extending through the adapter into said stem chamber. The bleedway is in communication with a seal surrounding the stem chamber.

The present invention includes an actuator adapter having a body. The body has an actuator end and a valve body end. The body includes a stem chamber extending therethrough. The valve body end of the body of the adapter can define a valve body cover and a portion defining a set of holes for attaching the body to a valve body. The actuator end of the body has a portion defining a set of holes for attaching the adapter to an actuator. The set of holes of the adapter can be spaced radially on the portion of the actuator end of the adapter and can be conforming to a standard spacing protocol. The standard protocol is the ISO standard spacing protocol for valve actuators. The portion of the actuator end of the body having said set of holes is a flange.

The actuator adapter can include a portion for attaching an actuator, wherein a different spacing of the additional set of holes conforms to ISO standard spacing protocol. The body can further provide a bleedway extending through the body into the stem chamber.

The present invention provides a method of assembling a plug valve. The method includes providing a valve body having an upper end defining a set of holes and a valve cylinder having a first port at one end thereof and a second port on an opposite end thereof. The valve body provides an actuator having a portion defining a set of receiving holes, an adapter having an actuator end, a valve body cover end and a stem chamber extending through the adapter. The actuator end has a flanged portion defining a set of holes corresponding to the set of receiving holes of the actuator. The valve body cover end has a flanged portion defining a set of holes. The set of holes attaches the valve body cover end of the adapter to the upper end of said valve body and the actuator end of the adapter to the actuator by extending a member through one hole of a set of holes of the adapter and then the receiving set of holes of the actuator.

The method further includes a conforming set of holes of the flanged portion of the actuator end to ISO standard spacing.

The present invention includes detecting faulty packing in a plug valve by providing a valve body having a first end, a second end and a set of holes defined on the first end, defining a valve cylinder having an inlet port at one end thereof and an outlet port thereon, which provides a valve stem having a valve plug on the distal end, an actuator defining a set of receiving holes and an adapter having an actuator end, a valve body end and a stem chamber extending through the adapter. Next, the actuator end has a flanged portion defining a set of holes for receiving a member and defining a bleedway in an area between the actuator and valve body end. Then the adapter is placed over the stem valve where the valve stem contacts a seal inside the chamber of said adapter, the seal further contacting the adapter. Next, attaching the valve body end to the adapter and then the actuator end of the adapter to the actuator by placing a member into the holes of the adapter and then into the holes of the actuator. Finally, the liquid can penetrate the adapter through a bleedway, indicating leakage inside the plug valve. The set of holes of the adapter can be conforming to ISO standards.

### BRIEF DESCRIPTION OF THE DRAWING(S)

FIG. 1 is an elevational view, partly in cross-section of a plug valve;

FIG. 2 is a side view, in cross section of the plug valve of FIG. 1; and

FIG. 3 is a top plan view of the flanged valve body showing the hex head cap screw arrangement fastening the actuator to the valve.

### DESCRIPTION OF THE PREFERRED EMBODIMENT(S)

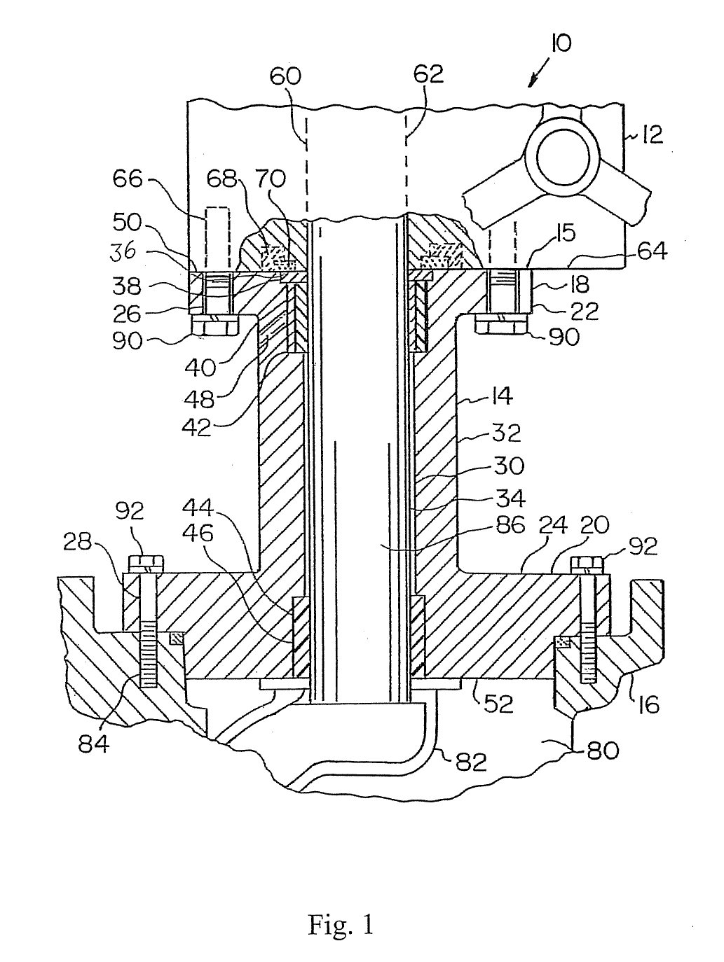

Referring to FIG. 1, the present invention is a plug valve 10 used to control the movement of liquids. The plug valve 10 includes a valve actuator 12, an adapter 14 and a valve body 16. Plug valve 10 includes flanged portion 22 on actuator end 18 of adapter 14 in addition to a flanged portion 24 on a valve body end 20 of adapter 14. The adapter 14 defines a set of holes 26 spaced radially along the outside of flanged portion 22 on the actuator end 18. The set of holes 26 are preferably threaded for receiving threaded members. The adapter 14 further defines another set of holes 28 spaced radially along the flanged portion 24 of valve body end 20. The set of holes 28 are preferably threaded for receiving threaded members. The adapter 14 has an inner surface 30 and an outer surface 32. The inner surface 30 of adapter 14 defines a stem chamber 34. On the inner surface 30 of stem chamber 34 of the adapter 14, a recess 36 is defined near actuator end 18. Directly below the recess 36 is a second longitudinally extended recess 40, which extends along the inner surface 30 of stem chamber 34 of the adapter 14. A seal 42 is created by placing packing material (such as fiber woven packing) into second longitudinally extended recess 40, and packed tight, forming the seal 42 in the stem chamber 34 against a driveshaft 86. The recess 36 is shown having a packing retaining washer 38 which can be applied directly against the seal 42 in the second longitudinally extended recess 40, the retaining washer 38 for holding seal 42 in place. Packing retaining washer 38 can be placed directly into recess 36 forming a tight fit against the seal 42 thereby holding it in place inside second longitudinally extended recess 40. On the valve body end 20 of adapter 14, the inner surface 30 defines a bearing recess 44 which extends from the valve body end 20 of adapter 14 upward on the stem chamber 34 for holding a seal 46. To form a liquid-tight seal between the adapter 14 and the driveshaft 86 at the valve body end 20 of adapter 14, the seal 46 is created by placing packing material into recess 44. Packing retaining washer 38 can be held in place by the bottom end 64 of actuator 12, likewise, seal 46 can be held in place by the valve body 16.

Adapter 14 can further include a bleedway 48. Bleedway 48 is a small passageway in the adapter 14 in fluid connection with the stem chamber 34, for passing liquid between inner surface 30 and outer surface 32 of the adapter 14 indicating leakage inside the stem chamber 34. Multiple bleedways can be provided. The adapter 14 can be made of cast iron, steel or any other material known in the art.

Adapter 14 is coupled to the valve actuator 12 when members 90, preferably in the form of a screw or a set screw, are received by the set of holes 26 of adapter 14 and a set of holes of valve actuator 12 formed in valve body end 64 of valve actuator 12. Before placing members 90 into the set of holes 26, the set of holes 26 of adapter 14 are aligned so that members 90 can be adjusted therethrough the set of holes 26 and into the set of holes 66. When the threaded members 90 are inserted and threadably adjusted into the set of holes 26 of the adapter 14 and the set of holes 66 of the valve actuator 12, the top end of adapter 14 is drawn tightly to the valve body end 64 of the valve actuator 12. Valve actuator 12 further includes an inner surface 60 which forms an axial bore 62.

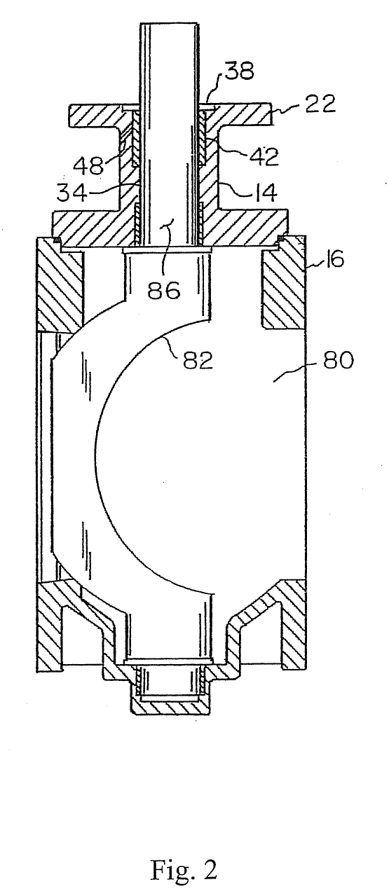

As shown in FIGS. 1 and 2, the flanged portion 24 is coupled to the valve body 16 when a threaded member 92, (such as a screw or a set screw) is received by the set of holes 28 of adapter 14 and a set of holes 84 of valve body 16. Before placing threaded members 92 into the set of holes 28, the set of holes 28 of adapter 14 are aligned with the set of holes 84 of valve body 16. Threaded members 92 are inserted and adjusted therethrough the aligned set of holes 28, 84. A bottom surface 52 of adapter 14 is drawn tightly to the valve body 16, forming a tight fit onto valve body 16.

Valve body 16 further includes a valve chamber 80. An Eccentric Plug Valve 82 can be positioned within valve chamber 80 and attached to the driveshaft 86 which extends upward through the stem chamber 34 of adapter 14. Valve body 16 is an Eccentric Plug Valve, which is known in the art. One such valve is the MILLCENTRIC™ Eccentric Plug Valve manufactured by Milliken Valve Company. Other similar designs are manufactured by VAL-MATIC Valve and Manufacturing Corporation and Henry Pratt Company.

Alternatively, adapter 14 can have an annular lip 68 (shown in phantom in FIG. 1) at the actuator end 18 on a top surface 15. The annular lip 68 can be used to attach a torque collar (not shown) to the adapter 14. Adapter 14 can also have a gasket 70 (shown in phantom) applied between the lip 68 and a top surface 50 of adapter 14. Beneath the gasket 70 is packing retainer washer 38. The packing retaining washer 38 is held in place by the gasket 70 in this alternative embodiment. Lip 68 remains when the plug valve 10 is to be formed of a torque collar and can be removed from adapter 14 by machining the lip 68 from the adapter 14 when plug valve 10 is formed on a valve actuator 12. When the lip 68 is removed, the top surface 50 of adapter 14 becomes the surface as shown.

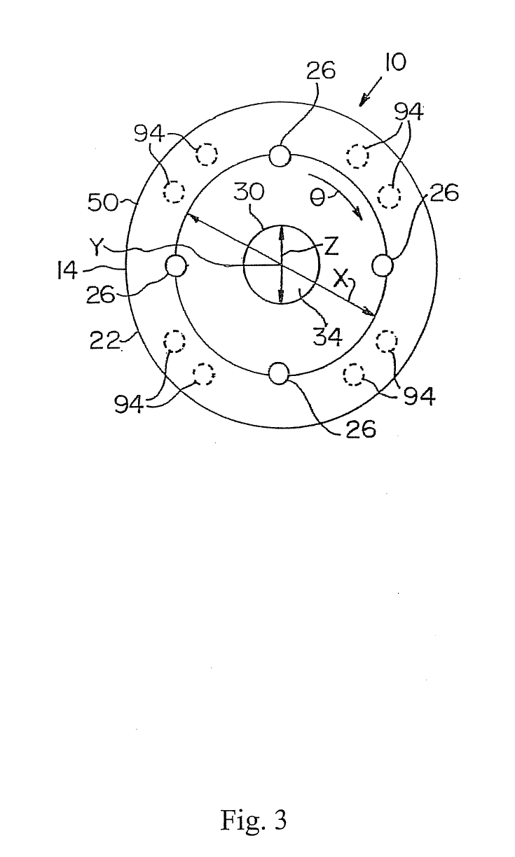

With reference to FIG. 3, the top surface 50 of plug valve 10 is shown with like parts labeled with like numbers. The plug valve 10 includes the adapter 14 with the flanged portion 22 and the stem chamber 34. Fasteners (not shown) are received in the set of holes 26. The set of holes 26 can be spaced radially according to International Organization for Standardization (ISO) standards.

As is known in the art, the ISO is a global network that identifies International Standards required by business, government and society. The ISO develops the standards in partnership with business sectors. The ISO standards can be very useful since they ease actuator exchanges, because the valve body receives different actuators when the holes are drilled to ISO standards. In the prior art, it is believed that every valve body had its own unique standard spacing, creating endless numbers of possible actuator spacings. In order for an actuator to fit one of these valve bodies, the method was cumbersome and extra components were needed. The extra components were adapters attached to the actuator and the valve body cover, allowing the actuators to fit a particular valve body. These adapters added additional expense and complexity and greatly decreased flexibility when choosing components because the adapter was only fitted to one particular actuator.

With continuing reference to FIG. 3, the set of holes 26 can be spaced apart radially around the flanged portion 22 of adapter 14 forming a circle with a diameter X through the center Y, having a standard angle θ between the set of holes 26 as shown in FIG. 3. Also, the set of holes 26 can be a standard size for different sizes of fasteners. The diameter of the stem chamber 34 can be a standard size having diameter Z to match any standard plug stem.

Within the flanged portion 22 of adapter 14, there can be any number of additional holes 94 (shown in phantom). These additional holes 94 can be included to fit any number of additional actuators (not shown) different from the first valve actuator 12. These additional holes 94 can be circumferentially spaced on adapter 14. They can be present to fit additional actuators (not shown) having different standardized arrangements of holes. For example, a second actuator (not shown) can be provided having a set of holes coinciding to the additional holes 94 (shown in phantom) of adapter 14. The additional set of holes 94 and those of a second actuator can be aligned and a member adjusted therein as in the preferred embodiment. The additional holes 94 allow a standard actuator, which can be available on the market to fit readily onto the plug valve 10. Placing different combinations of standardized holes on the adapter 14 can allow many different types of actuators addressing different problems, as discussed above, to be attached to the adapter 14 which is also coupled to the valve body 16 to form the plug valve 10, thereby providing flexibility to change actuators quickly, if needed.

A high pressure actuator is one example where changing an actuator can address a particular problem. High pressure actuators can be utilized on a valve body to facilitate opening and closing a highly pressurized valve. A high pressurized actuator is only needed in those situations where there is high pressure. Therefore, since the adapter 14 can provide multiple combinations of holes, it can support a standard type actuator for normal use and also a high pressure actuator as the situation dictates. In addition, the valve actuator 12 can also be removed to change the packing retaining washer 38 or seal 42 within the adapter 14. Combinations of holes can similarly be provided on the valve body end 20 of adapter 14 to meet similar requirements for the valve body 16.

Referring back to FIG. 1, the packing retaining washer 38 or, seal 42, 46 can degrade over time, begin to fill with liquid, and leak into the stem chamber 34. In order to determine that the seals 42, 46 need to be replaced, the bleedway 48 is provided on the adapter 14 between the outer surface 32 and the inner surface 30. Liquid visibly forming outside the adapter 14 on the outer surface 32 is seen as an indication that the packing retaining washer 38 or seal 42, 46 is not functioning properly to block liquid from entering the chamber 34. In this arrangement, the seal 42 can be replaced by removing the members 90 from the set of holes 26 of adapter 14 and the set of holes 66 of valve actuator 12, and removing the adapter 14 from the valve actuator 12. The packing retaining washer 38 is then removed thereby exposing the seal 42. Once the new seal 42 is placed into the second longitudinally extended recess 40 of adapter 14, the valve actuator 12 is replaced and fastened to the top surface 50 of adapter 14 by placing the threaded members 90 into the threaded set of holes 26, 28.

The present invention overcomes further deficiencies of the prior art in that the removal of valve actuator 12 is accomplished by removal of the threaded members 90 without the necessity of removing a valve actuator cover because the threaded members 90 are inserted into the adapter 14 and actuator 12 from the bottom instead of removing an actuator cover (not shown) and placing threaded members into the actuator 12. Also, the bottom surface 52 of adapter 14 acts as a cover to the valve body 16 when adapter 14 is coupled to the valve body 16. The further prior deficiency of providing both an adapter and a valve cover is overcome by providing the adapter with the bottom surface 52 providing both adapter and valve body cover functions.

The present invention provides a method for assembling a plug valve. A valve actuator 12, adapter 14 and valve body 16 are provided as discussed previously. The adapter 14 is placed under the valve actuator 12, with the set of holes 66 aligned to the set of holes 26 of the adapter 14. Members, preferably threaded members 90 in the form of hex head cap screws, are individually inserted into the set of holes 26 and then into the set of holes 66 of the valve actuator 12. The type of members is not meant to be limiting as one of ordinary skill in the art can envision other types of members which can be used as fasteners. The adapter 14 and the valve actuator 12 coupled assembly is then placed on the upper end of the valve body 16 and coupled thereto. The adapter 14 is coupled to the valve actuator 12 by adjusting the threaded members 92 through the set of holes 28 of adapter 14 into the set of holes 66 of valve actuator 12. When the holes of the actuator 12 are conforming to ISO standards instead of customized, an adapter 14 can be provided having a set of holes 28 conforming to ISO standards based for actuators. However, any standard body that governs the placement of holes can be used. When the adapter 14 is provided having multiple spacings, the spacing that matches the spacing on the actuator 12 can be used. ISO standard holes can be provided on the valve body 16 as well, in which case the set of holes of the adapter 14 is defined conforming to ISO standards for valve bodies.

A method for detecting faulty packing in a plug valve is provided in the present invention. The plug valve is formed as in the previous method, the adapter 14 having a bleedway 48 between the inner surface 30 and the outer surface 32 of the adapter 14 and an airtight pocket between the seal 46 and the seal 42. The adapter 14 can define multiple bleedways. Packing retaining washer 38, seal 42 and seal 46 are provided in recess 36, second longitudinally extended recess 40 and bearing recess 44, respectively, of the inner surface 30 of adapter 14. However, as the packing retaining washer 38, seal 42 or seal 46 loosen, decay or become damaged and liquid extends up into the stem chamber 34, the liquid will eventually leak through a bleedway 48. The liquid forms on the outside surface 32 of adapter 14. The liquid formation on the outside surface 32 acts as a signal of damaged packing retaining washer 38 or seal 42, 46. The actuator can be removed by removing the threaded members 90 from the holes 26, 66. Once the actuator 12 is removed, the seals 42, 46 can be checked and fixed, if needed, by replacing with new packing material.

It will be readily appreciated by those skilled in the art that modifications may be made to the invention without departing from the concepts disclosed in the foregoing description. Accordingly, the particular embodiments described in detail here and are illustrative only and are not limiting to the scope of the invention, which is to be given to the full breadth of the appending claims and all equivalents thereof.

The invention claimed is:

1. A plug valve, comprising:
a valve body having a first end defining a set of holes and a first port and a second port;
an actuator having a portion defining a set of holes;
an adapter having an actuator end, a valve body end and a stem chamber extending through said adapter, the valve body end attached to the first end of the valve body by a member extending through a set of holes defined on a portion of said valve body end corresponding to a set of holes of the valve body, said actuator end of said adapter attached to said actuator by a member extending through a set of holes of a portion of the actuator end of the adapter into the corresponding receiving set of holes in the actuator; and
a valve stem rotatably positioned in said stem chamber, said valve stem having a valve end for attaching a valve member having a communication hole for communicating with said first port and said second port.

2. The plug valve according to claim 1, wherein said set of holes of the adapter are spaced radially on the portion of the actuator end of said adapter conforming to a standard protocol.

3. The plug valve according to claim 2, wherein said standard protocol is the ISO standard spacing protocol for valve actuators.

4. The plug valve according to claim 3, wherein said portion of the adapter defines an additional set of holes for attaching an actuator, wherein a different spacing of the additional set of holes conforms to ISO standard spacing protocol.

5. The plug valve according to claim 1, wherein said portion of said actuator end of said adapter containing said set of holes is a flange.

6. The plug valve according to claim 1, wherein the valve end is a plug.

7. The plug valve according to claim 1, wherein said portion of said valve body end of said adapter containing the set of holes is a flange.

8. The plug valve according to claim 1, wherein said valve body end of the adapter defines a valve body cover.

9. The plug valve according to claim 1, wherein the adapter defines a bleedway extending through said adapter into said stem chamber.

10. The plug valve according to claim 1, wherein the bleedway is in communication with a seal surrounding the stem chamber.

11. An actuator adapter, comprising:
a body having an actuator end and a valve body end; and
said body having a stem chamber extending therethrough, said valve body end of body defining a valve body cover and having a portion defining a set of holes for attaching said body to a valve body, said actuator end of body having a portion defining a set of holes for attaching the adapter to an actuator.

12. The actuator adapter according to claim 11, wherein said set of holes of the adapter are spaced radially on the portion of the actuator end of said adapter conforming to a standard spacing protocol.

13. The actuator adapter according to claim 12, wherein said standard protocol is the ISO standard spacing protocol for valve actuators.

14. The actuator adapter according to claim 12, wherein said portion of the actuator end of said body having said set of holes is a flange.

15. The actuator adapter according to claim 12, wherein said portion of the actuator end defines an additional set of holes for attaching an actuator, wherein a different spacing of the additional set of holes conforms to ISO standard spacing protocol.

16. The actuator adapter according to claim 11, wherein said portion of the valve body end of said body is a flange.

17. The actuator adapter according to claim 11, wherein the body has a bleedway extending through said body into said stem chamber.

18. A method for assembling a valve plug, comprising:
providing a valve body having an upper end defining a set of holes and a valve cylinder having a first port at one end thereof and a second port on an opposite end thereof;
providing an actuator having a portion defining a set of receiving holes;
providing an adapter having an actuator end, a valve body cover end and a stem chamber extending through said adapter, said actuator end having a flanged portion defining a set of holes corresponding to said set of receiving holes of the actuator, said valve body cover end having a flanged portion defining a set of holes;
attaching said valve body cover end of the adapter to the upper end of said valve body; and
attaching said actuator end of the adapter to said actuator by extending a member through one hole of a set of holes of the adapter and then the receiving set of holes of the actuator.

19. A method according to claim 18, wherein said set of holes of said flanged portion of said actuator end of the adapter are conforming to ISO standard spacing.

20. A method for detecting faulty packing in a plug valve, comprising:
providing a valve body having a first end, a second end and a set of holes defined on the first end, defining a valve cylinder having an inlet port at one end thereof and an outlet port thereon;
providing a valve stem having a valve plug on the distal end;
providing an actuator defining a set of receiving holes;
providing an adapter having an actuator end, a valve body end and a stem chamber extending through said adapter, said actuator end having a flanged portion defining a set of holes for receiving a member and defining a bleedway in an area between said actuator and valve body end;
placing said adapter over said stem valve where the valve stem contacts a seal inside said chamber of said adapter, said seal further contacts said adapter;
attaching said valve body end to the adapter;
attaching said actuator end of the adapter to said actuator by placing a member into said holes of said adapter and then into said holes of said actuator; and
penetrating, by a liquid, and passing through the bleedway.
